(19) United States
(12) Patent Application Publication
(10) Pub. No.: US 2006/0090098 A1
(43) Pub. Date: Apr. 27, 2006

(54) Proactive data reliability in a power-managed storage system

(75) Inventors: Kim B. Le, Broomfield, CO (US); Jeffrey Cousins, Louisville, CO (US); Aloke Guha, Louisville, CO (US)

Correspondence Address: Trellis Intellectual Property Law Group, PC, 1900 EMBARCADERO ROAD, SUITE 109, PALO ALTO, CA, 94303, US

(73) Assignee: COPAN Systems, Inc., Longmont, CO (US)

(21) Appl. No.: 11/281,697

(22) Filed: Nov. 16, 2005

Related U.S. Application Data
(63) Continuation-in-part of application No. 11/043,449, filed on Jan. 25, 2005.
Application No. 11/043,449 is a continuation-in-part of application No. 10/937,226, filed on Sep. 8, 2004.
(60) Provisional application No. 60/501,849, filed on Sep. 11, 2003.

(51) Int. Cl. G06F 11/00

(52) U.S. Cl. 714/6

(57) ABSTRACT

Methods and systems for maintaining data reliability in a particular disk drive that is powered off in a storage system are disclosed. The methods include checking a power budget to determine that sufficient power is available, powering on the particular disk drive, and checking the particular disk drive to detect an error. Further, the method includes correcting the particular disk drive when the error is detected.

### CLAIM OF PRIORITY

This application is a continuation-in-part of the following application, which is hereby incorporated by reference, as if it is set forth in full in this specification:

U.S. patent application Ser. No. 11/043,449 entitled ‘Method and System for Disk Drive Exercise and Maintenance of High-Availability Storage Systems’, filed on Jan. 25, 2005.

This application is a further a continuation-in-part of the following application, which is hereby incorporated by reference, as if it is set forth in full in this specification:

U.S. patent application Ser. No. 10/937,226 entitled ‘Method for Proactive Drive Replacement for High-Availability Storage Systems’, filed on 8 Sep. 2004 which claimed priority to U.S. Provisional Application Ser. No. 60/501,849 entitled ‘Method for Proactive Drive Replacement for High Availability Raid Storage Systems’, filed Sep. 11, 2003.

This application is related to the following application, which is hereby incorporated by reference, as if set forth in full in this specification:

Co-pending U.S. patent application Ser. No. 10/607,932, entitled ‘Method and Apparatus for Power-Efficient High-Capacity Scalable Storage System’, filed on 12 Sep. 2002.

### BACKGROUND

The present invention relates generally to digital processing systems. More specifically, the present invention relates to a method of preventing failure of disk drives in high-availability storage systems.

Typically, data storage systems in computing applications include storage devices such as hard disk drives, floppy drives, tape drives, compact disks, and so forth. An increase in the amount and complexity of these applications has resulted in a proportional increase in the demand for larger storage capacities. Consequently, the production of high-capacity storage devices has increased in the past few years. Large storage capacities demand reliable storage devices with reasonably high data-transfer rates. Various data-storage system configurations and topologies using multiple storage devices are commonly used to meet the growing demand for increased storage capacity.

A configuration of the data storage system, to meet the growing demand, involves the use of multiple disk drives. Such a configuration permits redundancy of stored data. Redundancy ensures data integrity in the case of device failures. In many such data-storage systems, recovery from common failures can be automated within the data storage system by using data redundancy such as parity and its generation, with the help of a central controller. However, such data-redundancy schemes may be an overhead of the data storage system. These data-storage systems are typically referred to as Redundant Array of Inexpensive/independent Disks (RAIDs). The 1988 publication by David A. Patterson et al., from the University of California at Berkeley, titled ‘A Case for Redundant Arrays of Inexpensive Disks (RAIDs)’, describes the fundamental concepts of the RAID technology.

RAID storage systems suffer from inherent drawbacks that reduce their availability. If a disk drive in the RAID storage system fails, data can be reconstructed with the help of redundant drives. The reconstructed data is then stored in a replacement disk drive. During reconstruction, the data on the failed drive is not available. Further, if more than one disk drive fails in a RAID system, data on both drives cannot be reconstructed if there is single drive redundancy, resulting in possible loss of data. The probability of disk drive failure increases as the number of disk drives in a RAID storage system increases. Therefore, RAID storage systems with a large number of disk drives are typically organized into several smaller RAID systems. This reduces the probability of data loss in large RAID systems. Further, the use of smaller RAID systems also reduces the time it takes to reconstruct data on a spare disk drive in the event of a disk drive failure. When a RAID system loses a critical number of disk drives, there is a period of vulnerability from the time the disk drives fail until the time data reconstruction on the spare drives is completed. During this time, the RAID system is exposed to the possibility of additional disk drives failing, which would cause an unrecoverable data loss. If the failure of one or more disk drives can be predicted, with sufficient time to replace the drive or drives before a failure or failures, a drive or drives can be replaced without sacrificing fault tolerance, and data reliability and availability can be considerably enhanced.

Various methods and systems are known that predict the impending failure of disk drives in storage systems. However, these methods and systems predict the impending failure of disk drives that are used frequently to process requests from computers. The reliability of disk drives that are not used, or used infrequently, is not predicted by known methods and systems.

### SUMMARY

In accordance with one embodiment of the present invention, a method for preventing loss of data in a particular disk drive in a storage system is provided. The storage system includes a plurality of disk drives and a particular disk drive, wherein the particular disk drive is powered off. The method includes checking a power budget to determine that sufficient power is available to power on the particular disk drive, powering on the particular disk drive, checking the particular disk drive, and correcting the particular disk drive in response to the checking.

In accordance with another embodiment of the present invention, a system for preventing loss of data in a particular disk drive in a storage system is provided. The storage system includes a plurality of disk drives and a particular disk drive, wherein the particular disk drive is powered off. The system includes a power budget checker, a power controller, a checking-module, and a correction-module. The power budget checker checks the power budget to determine that sufficient power is available to power on the particular disk drive. The power controller controls the power to the disk drives and the particular disk drive. The checking-module checks the particular disk drive, and the correction-module corrects the particular disk drive.

In accordance with another embodiment the present invention, a method for repairing a particular disk drive in a storage system is provided. The storage system includes a plurality of disk drives and a particular disk drive, wherein the particular disk drive is powered off. The method includes checking of a power budget to determine that sufficient power is available to power on the particular disk drive, powering on the particular disk drive, and correcting the damaged logical blocks in response to the checking.

In accordance with another embodiment of the present invention, a system for repairing a particular disk drive in a storage system is provided. The storage system includes a plurality of disk drives and the particular disk drive that is powered off. The system includes a power budget checking unit, a power controller, and a correction-unit. The power budget checking unit checks the power budget to determine that sufficient power is available to power on the particular disk drive. The power-controller controls the power to the disk drives, and the particular disk drive. The correction-unit corrects the damaged logical blocks.

### BRIEF DESCRIPTION OF THE DRAWINGS

Various embodiments of the present invention will hereinafter be described in conjunction with the appended drawings, provided to illustrate and not to limit the present invention, wherein like designations denote like elements, and in which:

FIG. 1 is a block diagram illustrating a storage system, in accordance with an embodiment of the present invention;

FIG. 2 is a block diagram illustrating the components of a memory and a Central Processing Unit (CPU) and their interaction in accordance with an embodiment of the present invention;

FIG. 3 is a flowchart of a method for preventing the failure of disk drives in a storage system, in accordance with one embodiment of the present invention;

FIG. 4 is a graph showing an exemplary variation of mean-time-to-failure of a disk drive with temperature;

FIG. 5 is a flowchart of a method for preventing the failure of disk drives in a storage system, in accordance with another embodiment of the present invention;

FIG. 6 is a flowchart of a method for preventing the failure of disk drives in a storage system, in accordance with another embodiment of the present invention;

FIG. 7 is a block diagram illustrating the components of a memory and a Central Processing Unit (CPU), and their interaction, in accordance with another embodiment of the present invention;

FIG. 8 is a flowchart of a method for maintaining a particular disk drive in a storage system, where the particular disk drive is powered off, in accordance with an embodiment of the present invention;

FIG. 9 is a flowchart of a method for maintaining a particular disk drive in a storage system, where the particular disk drive is powered off, in accordance with another embodiment of the present invention;

FIG. 10 is a flowchart of a method for executing a test on the particular disk drive, in accordance with an embodiment of the present invention;

FIG. 11 is a flowchart of a method for executing a test on the particular disk drive, in accordance with another embodiment of the present invention;

FIG. 12 is a block diagram illustrating the components of a memory and a Central Processing Unit (CPU), and their interaction, to prevent loss of data in a particular disk drive, in accordance with one embodiment of the present invention;

FIG. 13 is a flowchart of a method for preventing loss of data in a particular disk drive in a storage system, where the particular disk drive is powered off, in accordance with an embodiment of the present invention;

FIG. 14 is a flowchart of a method for checking a particular disk drive in a storage system, in accordance with an embodiment of the present invention;

FIG. 15 is a flowchart of a method for cloning a particular disk drive in a storage system, in accordance with an exemplary embodiment of the present invention;

FIG. 16 is a block diagram illustrating the components of a memory and a Central Processing Unit (CPU), and their interaction, to repair a particular disk drive, in accordance with another embodiment of the present invention;

FIG. 17 is a flowchart of a method for repairing a particular disk drive in a storage system, where the particular disk drive is powered off, in accordance with an embodiment of the present invention;

FIG. 18 is a flowchart of a method for correcting damaged logical blocks in a particular disk drive in a storage system, in accordance with an embodiment of the present invention; and

FIG. 19 is a flowchart of a method for replacing the damaged logical blocks with good logical blocks in a particular disk drive in a storage system, in accordance with an embodiment of the present invention.

### DESCRIPTION OF VARIOUS EMBODIMENTS

Embodiments of the present invention provide a method, system and computer program product for preventing the failure of disk drives in high availability storage systems. Failure of disk drives is predicted and an indication for their replacement is given. Failure is predicted by the monitoring of factors, including those relating to the aging of disk drives, early onset of errors in disk drives and the acceleration of these factors.

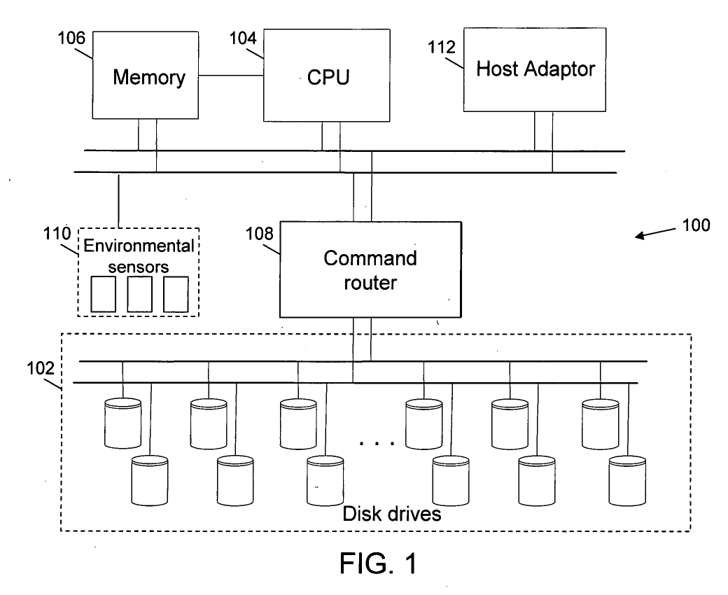

FIG. 1 is a block diagram illustrating a storage system 100 in accordance with an embodiment of the invention. Storage system 100 includes disk drives 102, a Central Processing Unit (CPU) 104, a memory 106, a command router 108, environmental sensors 110 and a host adaptor 112. Storage system 100 stores data in disk drives 102. Further, disk drives 102 store parity information that is used to reconstruct data in case of disk drive failure. CPU 104 controls storage system 100. Among other operations, CPU 104 calculates parity for data stored in disk drives 102. Further, CPU 104 monitors factors of each disk drive in disk drives 102 for predicting failure.

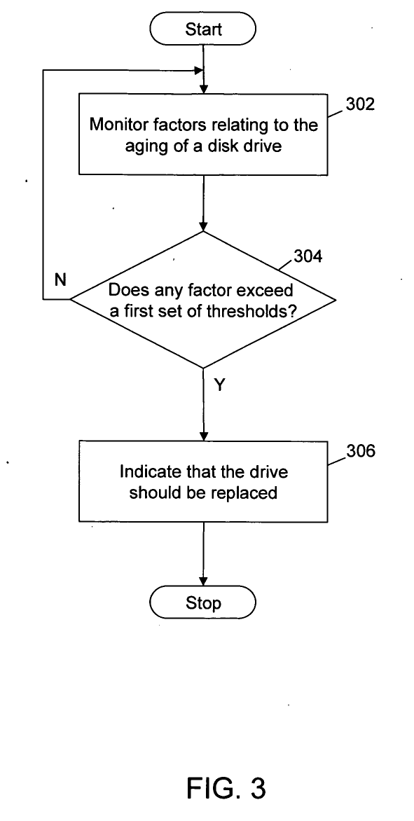

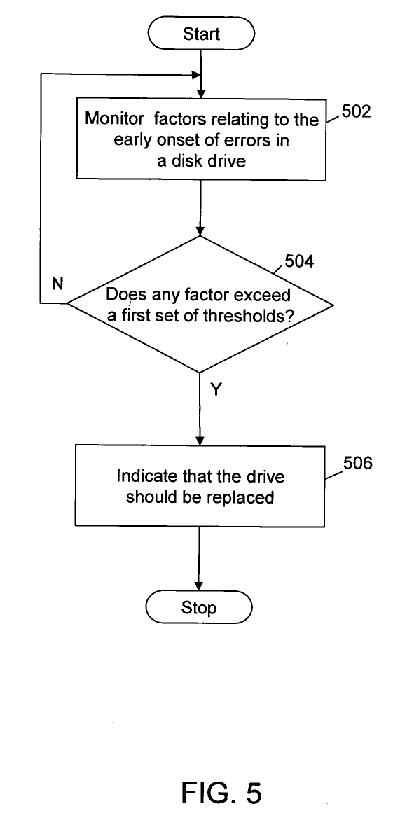

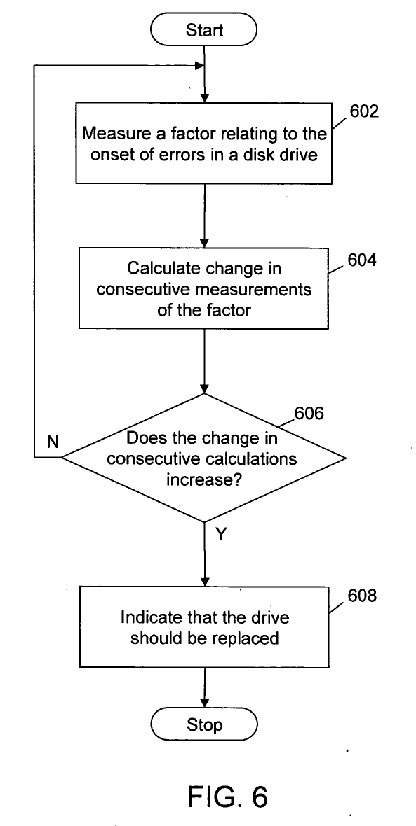

Exemplary factors for predicting disk drive failures include power-on hours, start stops, reallocated sector count, and the like. The method of predicting disk drive failure by monitoring the various factors is explained in detail in conjunction with FIG. 3, FIG. 5 and FIG. 6. Memory 106 stores the monitored values of factors. Further, memory 106 also stores values of thresholds to which the factors are compared. In an embodiment of the invention, Random Access Memory (RAM) is used to store the monitored values of factors and the threshold values. Command router 108 is an interface between CPU 104 and disk drives 102. Data to be stored in disk drives 102 is sent by CPU 104 through command router 108. Further, CPU 104 obtains values of factors for predicting disk drive failure through command router 108. Environmental sensors 110 measure environmental factors relating to the failure of disk drives 102. Examples of environmental factors that are measured by environmental sensors 110 include temperature of disk drives, speed of cooling fans of storage system 100, and vibrations in storage system 100. Host adaptor 112 is an interface between storage system 100 and all computers wanting to store data in storage system 100. Host adaptor 112 receives data from the computers. Host adaptor 112 then sends the data to CPU 104, which calculates parity for the data and decides where the data is stored in disk drives 102.

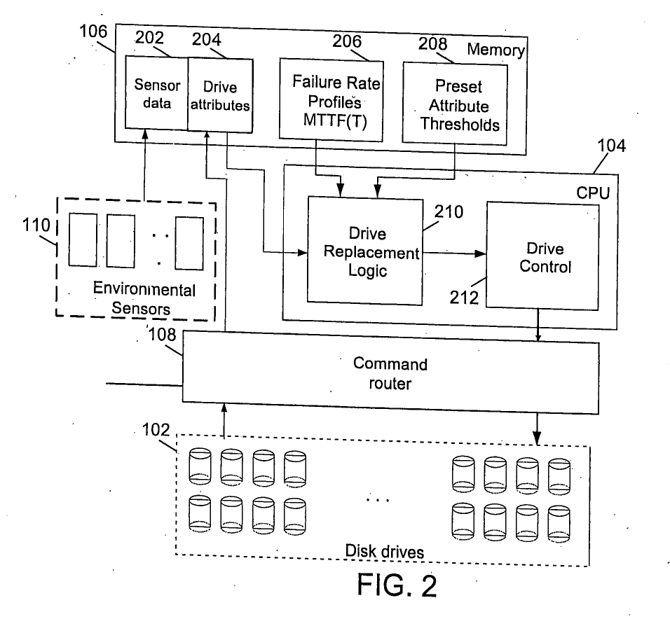

FIG. 2 is a block diagram illustrating the components of memory 106 and CPU 104 and their interaction, in accordance with an embodiment of the invention. Memory 106 stores sensor data 202 obtained from environmental sensors 110, drive attributes 204 obtained from each of disk drives 102, failure rate profiles 206, and preset attribute thresholds 208. In order to predict failure of each disk drive in disk drives 102, sensor data 202 and drive attributes 204 are compared with failure rate profiles 206, and preset attribute thresholds 208. This prediction is described later in conjunction with FIG. 3, FIG. 5 and FIG. 6. CPU 104 includes drive replacement logic 210 and drive control 212. The comparison in sensor data 202, drive attributes 204, failure rate profiles 206, and preset attribute thresholds 208 is performed by drive replacement logic 210. Once failure for a disk drive in disk drives 102 is predicted drive control 212 indicates that the disk drive should be replaced. The indication can be external in the form of an LED or LCD that indicates which drive is failing. Further, the indication can be in the form of a message on a monitor that is connected to CPU 104. The message can also include information regarding the location of the disk drive and the reason for the prediction of the failure. Various other ways of indicating disk drive failure are also possible. The manner in which this indication is provided does not restrict the scope of this invention. Drive control 212 further ensures that data is reconstructed or copied into a replacement disk drive and further data is directed to the replacement disk drive.

FIG. 3 is a flowchart of a method for preventing the failure of disk drives in storage system 100, in accordance with one embodiment of the present invention. At step 302, factors relating to the aging of each of disk drives 102 are monitored. At step 304, it is determined if any of the factors exceed a first set of thresholds. If the thresholds are not exceeded, the method returns to step 302 and this process is repeated. In case the thresholds are exceeded, an indication for the replacement of the disk drive, for which the factor has exceeded the threshold, is given at step 306. Factors that are related to aging include power-on hours (POH) and start stops (SS). POH is the cumulative number of hours for which a particular disk drive has been powered on. To predict disk drive failure, POH is compared to a preset percentage of the mean-time-to-failure (MTTF) of disk drives 102. This can be calculated by storage system 100 as disk drives fail. In another embodiment of the present invention, MTTF is calculated based on the mean temperature of disk drives 102. MTTF versus temperature graphs can be obtained from manufacturers of disk drives.

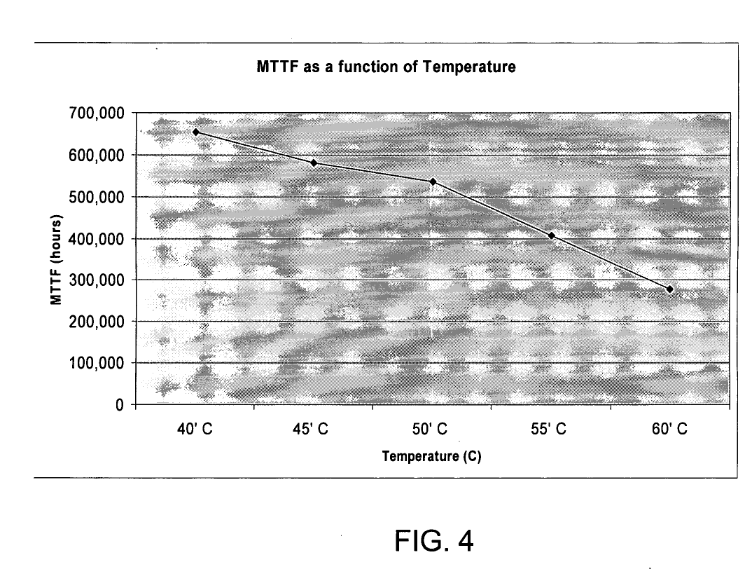

FIG. 4 is a graph showing an exemplary variation of MTTF with temperature. The graph shown is applicable for disk drives manufactured by one specific disk vendor. Similar graphs are provided by other disk drive manufacturers. These graphs can be piecewise graphs as shown in FIG. 4 or linear graphs. This depends on the experimentation conducted by the disk drive manufacturer. In accordance with another embodiment of the present invention, MTTF versus temperature graphs are stored as vector pairs of MTTF values and temperatures. These vector pairs are stored as failure rate profiles 206 in memory 106. For temperatures between the values stored in vector pairs, MTTF values are calculated by interpolation between consecutive vector pairs. The preset percentage for comparing the MTTF with the power-on hours of each of disk drives 102 can be chosen between 0 and 0.75 (exclusive), for example. Other percentages can be used. For example, one basis for choosing a percentage can be based on studies that have shown that useful life is smaller than that indicated by manufacturers' MTTF.

Therefore, an indication for replacement is given when:
POH>p*MTTF(T)

where, p=preset percentage for POH, 0<p<0.75, and

MTTF(T)=mean-time-to-failure calculated on the basis of temperature.

Start stops (SS) is the sum total of the number of times a disk drive completes a cycle of power on, disk drive usage and power off. To predict disk drive failure, SS is compared to a preset percentage of the maximum allowable value for the SS. This value is specified by drive manufacturers. Most drive manufacturers recommend the maximum allowable value for SS to be 50,000. The preset percentage for comparing the maximum allowable value of SS with the measured SS of each of disk drives 102 can be chosen between 0 and 0.9 (exclusive). Therefore, an indication for replacement of a disk drive is given when:
SS>c*SSₘₐₓ

where, c=preset percentage for SS, 0<c<0.9, and

SSₘₐₓ=maximum allowable value for SS, typically 50,000 as per current disk drive specifications.

FIG. 5 is a flowchart of a method for preventing the failure of disk drives in storage system 100, in accordance with another embodiment of the present invention. At step 502, factors relating to the early onset of errors in each of disk drives 102 are monitored. At step 504, it is determined if any of the factors exceed a first set of thresholds. If the thresholds are not exceeded, the method returns to step 502 and this process is repeated. In case any of the set of thresholds is exceeded, an indication for the replacement of the disk drive is given at step 506. Factors that are related to the early onset of errors include reallocated sector count (RSC), read error rate (RSE), seek error rate (SKE), spin retry count (SRC). RSC is defined as the number of spare sectors that have been reallocated. Data is stored in disk drives 102 in sectors. Disk drives 102 also include spare sectors to which data is not written. When a sector goes bad, i.e., data cannot be read or written from the sector, disk drives 102 reallocate spare sectors to store further data. In order to predict disk drive failure, RSC is compared to a preset percentage of the maximum allowable value for the RSC. This value is specified by the disk drive manufacturers. Most disk drive manufacturers recommend the maximum allowable value for RSC to be 1,500. The preset percentage for comparing the maximum allowable value of RSC with the measured RSC can be chosen between 0 and 0.7 (exclusive). Therefore, an indication for replacement is given when:
RSC>r*RSCₘₐₓ

where, r=preset percentage for RSC, 0<r<0.7, and

RSCₘₐₓ=maximum allowable value for RSC≈1,500

Read error rate (RSE) is the rate at which errors in reading data from disk drives occur. Read errors occur when a disk drive is unable to read data from a sector in the disk drive. In order to predict disk drive failure, RSE is compared to a preset percentage of the maximum allowable value for the RSE. This value is specified by disk drive manufacturers. Most disk drive manufacturers recommend the maximum allowable value for RSE to be one error in every 1024 sector read attempts. The preset percentage for comparing the maximum allowable value of RSE with the measured RSE of each of disk drives 102 can be chosen between 0 and 0.9 (exclusive). Therefore, an indication for replacement is given when:
RSE>m*RSEₘₐₓ

where, m=preset percentage for RSE, 0<m<0.9, and

RSEₘₐₓ=maximum allowable value for RSE≈1 read error/1024 sector read attempts

Seek error rate (SKE) is the rate at which errors in seeking data from disk drives 102 occur. Seek errors occur when a disk drive is not able to locate where particular data is stored on the disk drive. To predict disk drive failure, SKE is compared to a preset percentage of the maximum allowable value for the SKE. This value is specified by disk drive manufacturers. Most disk drive manufacturers recommend the maximum allowable value for SKE to be one seek error in every 256 sector seek attempts. The preset percentage for comparing the maximum allowable value of SKE with the measured SKE of each of disk drives 102 can be chosen between 0 and 0.9 (exclusive). Therefore, an indication for replacement is given when:
SKE>s*SKEₘₐₓ

where, s=preset percentage for RSE, 0<s<0.9, and

SKEₘₐₓ=maximum allowable value for SKE≈1 seek error/256 sector seek attempts

Spin retry count (SRC) is defined as the number of attempts it takes to start the spinning of a disk drive. To predict disk drive failure, SRC is compared to a preset percentage of the maximum allowable value for the SRC. This value is specified by disk drive manufacturers. Most disk drive manufacturers recommend the maximum allowable value for SRC to be one spin failure in every 100 attempts. The preset percentage for comparing the maximum allowable value of SRC with the measured SRC of each of disk drives 102 can be chosen between 0 and 0.3 (exclusive). Therefore, an indication for replacement is given when:
SRC>t*SRCₘₐₓ

where, t=preset percentage for SRC, 0<t<0.3, and

SRCₘₐₓ=maximum allowable value for SRC≈1 spin failure/100 attempts.

FIG. 6 is a flowchart of a method for preventing the failure of disk drives in storage system 100, in accordance with another embodiment of the present invention. At step 602, a factor relating to the onset of errors in each of disk drives 102 is measured. At step 604, changes in the value of the factor are calculated. At step 606, it is determined that the changes in the factor increase in consecutive calculations. If the thresholds are not exceeded, the method returns to step 602 and the process is repeated. In case, the change increases, an indication is given that the disk drive should be replaced at step 608. An increase in change in two consecutive calculations of the change indicates that errors within the disk drive are increasing and could lead to failure of the disk drive. In one embodiment of the present invention, reallocated sector count (RSC) is considered as a factor relating to the onset of errors. Therefore, an indication for drive replacement is given when:
RSC(i+2)−RSC(i+1)>RSC(i+1)−RSC(i) AND
RSC(i+3)−RSC(i+2)>RSC(i+2)−RSC(i+1) for any i

where, i=a serial number representing measurements

Other factors can be used. For example, spin retry count (SRC), seek errors (SKE), read soft error (RSE), recalibrate retry (RRT), read channel errors such as a Viterbi detector mean-square error (MSE), etc., can be used. As future factors become known they can be similarly included.

Thresholds for comparing the factors are obtained from manufacturers of disk drives. In one embodiment of the present invention, memory 106 stores thresholds specific to disk drive manufacturers. These thresholds and their corresponding threshold percentages are stored in memory 106 as preset attribute thresholds 208. This is useful in case plurality of disk drives 102 comprises disk drives obtained from different disk drive manufacturers. In this embodiment, factors obtained from a particular disk drive are compared with thresholds recommended by the manufacturer of the particular disk drive as well as empirical evidence gathered during testing of the drives.

Combinations of the factors discussed above can also be used for predicting the failure of disk drives. When combinations of factors are monitored, they are compared with the corresponding thresholds that are stored in memory 106. Further, environmental data obtained from environmental sensors 110 can also be used, in combination with the described factors, to predict the failure of disk drives. For example, in case the temperature of a disk drive exceeds a threshold value, an indication for replacement of the disk drive can be given.

The invention, as described above can also be used to prevent the failure of disk drives in power-managed RAID systems where not all disk drives need to be powered on simultaneously. The power-managed scheme has been described in the co-pending U.S. patent application ‘Method and Apparatus for Power Efficient High-Capacity Storage System’ referenced above. In this scheme, sequential writing onto disk drives is implemented, unlike simultaneous writing as performed in RAID 5 scheme. Sequential writing onto disk drives saves power because it requires powering up of one disk drive at a time.

Embodiments of the present invention also provide a method and apparatus for maintaining a particular disk drive in a storage system, where the particular disk drive is powered off. A power controller controls the power supplied to disk drives in the storage system. Further, a test-moderator executes a test on the particular disk drive. The power controller powers on the particular disk drive when the test is to be executed, and powers off the particular disk drive after the execution of the test.

Disk drives 102 include at least one particular disk drive that is powered off during an operation of storage system 100. In an embodiment of the present invention, the particular disk drive is powered off since it is not used to process requests from a computer. In another embodiment of the present invention, the particular disk drive is powered off since it is used as a replacement disk drive in storage system 100. In yet another embodiment of the present invention, the particular disk drive is powered off since it is used infrequently for processing requests from a computer.

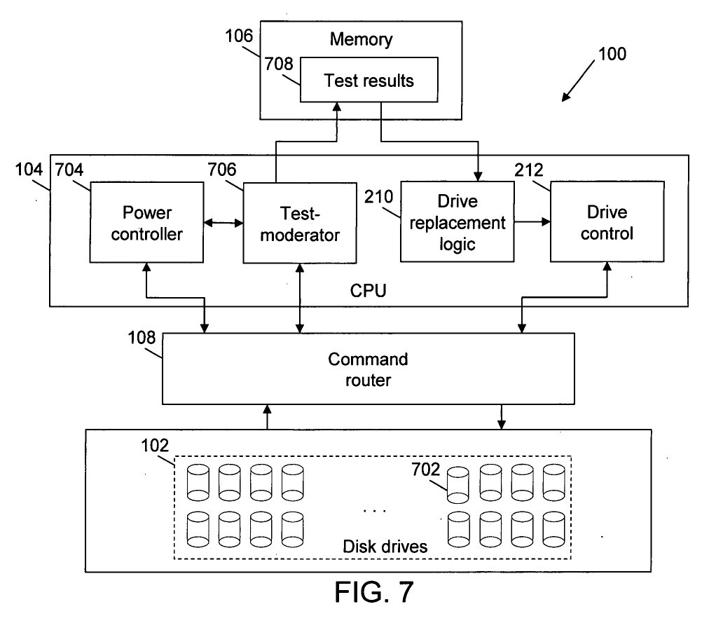

FIG. 7 is a block diagram illustrating the components of CPU 104 and memory 106 and their interaction, in accordance with another embodiment of the present invention. Disk drives 102 include at least one particular disk drive, for example, a disk drive 702 that is powered off. CPU 104 also includes a power controller 704 and a test-moderator 706. Memory 106 stores test results 708 obtained from test-moderator 706.

Power controller 704 controls the power to disk drives 102, based on the power budget of storage system 100. The power budget determines the number of disk drives that can be powered on in storage system 100. In an embodiment of the present invention, power controller 704 powers on limited numbers of disk drive because of the constraint of the power budget during the operation of storage system 100. Other disk drives in storage system 100 are only powered on when required for operations such as reading or writing data in response to a request from a computer. This kind of storage system is referred to as a power-managed RAID system. Further information pertaining to the power-managed RAID system can be obtained from the co-pending U.S. patent application, ‘Method and Apparatus for Power Efficient High-Capacity Storage System’, referenced above. However, the invention can also be practiced in conventional array storage systems. The reliability of any disk drive that is not powered on can be checked.

Test-moderator 706 executes a test on disk drive 702, to maintain it. Power controller 704 powers on disk drive 702 in response to an input from test-moderator 706 when the test is to be executed. Power controller 704 powers off disk drive 702 after the test is executed.

In an embodiment of the present invention, test-moderator 706 executes a buffer test on disk drive 702. As a part of the test, random data is written to the buffer of disk drive 702. This data is the read and is compared to the data that was written, which is referred to as a write/read/compare test of disk drive 702. The buffer test fails when, on comparing, there is a mismatch in written and read data. This is to ensure that the disk drives are operating correctly and not introducing any errors. In an exemplary embodiment of the present invention, a hex ‘00’ and hex ‘FF’ pattern is written for each sector of the buffer in disk drive 702. In another exemplary embodiment of the present invention, a write/read/compare hex ‘00’ and hex ‘FF’ pattern is written for sector buffer RAM disk drive 702.

In another embodiment of the present invention, test-moderator 706 executes a write test on a plurality of heads in disk drive 702. Heads in disk drives refer to magnetic heads that read data from and write data to disk drives. The write test includes a write/read/compare operation on each head of disk drive 702. The write test fails when, on comparing, there is a mismatch in written and read data. In an exemplary embodiment of the present invention, the write test is performed by accessing sectors on disk drive 702 that are non-user accessible. These sectors are provided for the purpose of self-testing and are not used for storing data. Data can also be written at any other sectors of the disk drives.

In yet another embodiment of the present invention, test-moderator 706 executes a random read test on disk drive 702. The random read test includes a read operation on a plurality of randomly selected Logical Block Addresses (LBAs). LBA refers to a hard disk sector-addressing scheme used on Small Computer System Interface (SCSI) hard disks and Advanced Technology Attachment Interface with Extensions (ATA) conforming to Integrated Drive Electronic (IDE) hard disks. The random read test fails when the read operation on at least one selected LBA fails. In an exemplary embodiment of the present invention, the random read test is performed on 1000 randomly selected LBAs. In an embodiment of the present invention, the random read test on disk drive 702 is performed with auto defect reallocation. Auto defect reallocation refers to reallocation of spare sectors on the disk drives, to store data when a sector is corrupted, i.e., data cannot be read or written from the sector. The random read test, performed with auto defect reallocation, fails when the read operation on at least one selected LBA fails.

In another embodiment of the present invention, test-moderator 706 executes a read scan test on disk drive 702. The read scan test includes a read operation on the entire surface of each sector of disk drive 702 and fails when the read operation on at least one sector of disk drive 702 fails. In an embodiment of the present invention, the read scan test on disk drive 702 is performed with auto defect reallocation. The read scan test performed with auto defect reallocation fails when the read operation on at least one sector of disk drive 702 fails.

In yet another embodiment of the present invention, combinations of the above-mentioned tests can also be performed on disk drive 702. Further, in various embodiments of the invention, the test is performed serially on each particular disk drive if there is a plurality of particular disk drives in storage system 100.

In various embodiments of the present invention, the results of the test performed on disk drive 702 are stored in memory 106 as test results 708, which include a failure checkpoint byte. The value of the failure checkpoint byte is set according to the results of the test performed, for example, if the buffer test fails on disk drive 702, the value of the failure checkpoint byte is set to one. Further, if the write test fails on disk drive 702, the value of the failure checkpoint byte is set to two, and so on. However, if the test is in progress, has not started, or has been completed without error, the value of the failure checkpoint byte is set to zero.

In various embodiments of the present invention, drive replacement logic 210 also predicts the failure of disk drive 702, based on test results 708. In an exemplary embodiment of the present invention, if the failure checkpoint byte is set to a non-zero value, i.e., the test executed on disk drive 702 by test-moderator 706 has failed; drive replacement logic 210 predicts the failure of disk drive 702. Once the failure of disk drive 702 is predicted, drive control 212 indicates that disk drive 702 should be replaced. This indication can be external to storage system 100, in the form of an LED or LCD that indicates which drive is failing. Further, the indication can be in the form of a message on a monitor that is connected to CPU 104; it can also include information pertaining to the location of disk drive 702 and the reason for the prediction of the failure. Various other ways of indicating disk drive failure are also possible. The manner in which this indicated does not restrict the scope of this invention. In an embodiment of the present invention, drive control 212 further ensures that data is reconstructed or copied into a replacement disk drive and further data is directed to the replacement disk drive.

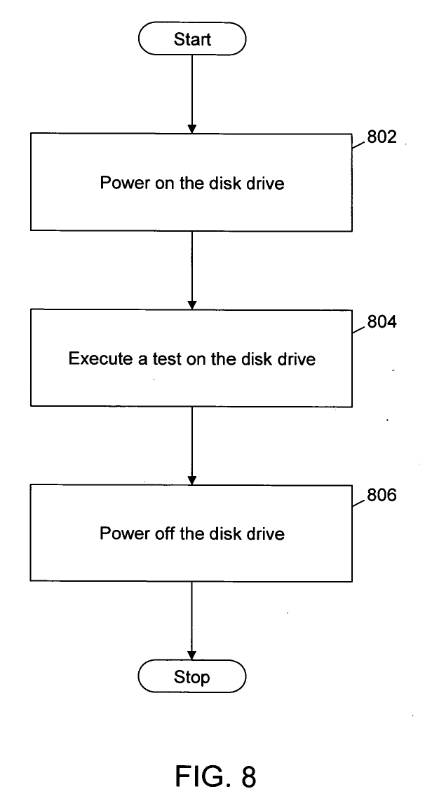

FIG. 8 is a flowchart of a method for maintaining disk drive 702 in storage system 100, in accordance with an embodiment of the present invention. At step 802, disk drive 702 is powered on. The step of powering on is performed by power controller 704. At step 804, a test is executed on disk drive 702. The step of executing the test is performed by test-moderator 706. The result of the test is then saved on test results 708 by test-moderator 706. Thereafter, disk drive 702 is powered off at step 806. The step of powering off is performed by power controller 704.

In an embodiment of the present invention, storage system 100 may not be a power-managed storage system. In this embodiment, all the disk drives in storage system 100 are powered on for the purpose of executing tests and are powered off after the execution of the tests.

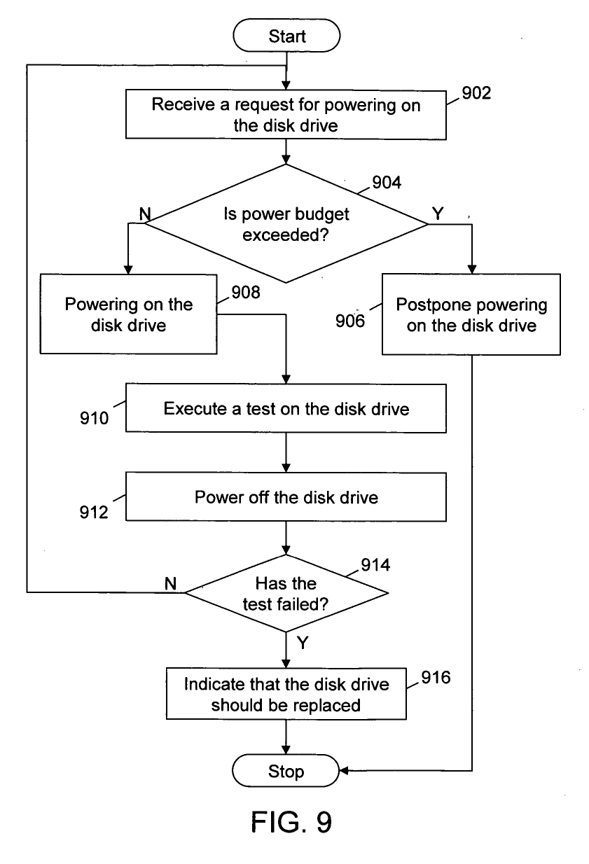

FIG. 9 is a flowchart of a method for maintaining disk drive 702 in storage system 100, in accordance with another embodiment of the present invention. A request for powering on disk drive 702 is received at step 902 by power controller 704. In an exemplary embodiment of the present invention, the request is sent by test-moderator 706. At step 904, it is then determined whether powering on disk drive 702 results in the power budget being exceeded. The step of determining whether the power budget is exceeded is performed by power controller 704. If the power budget has been exceeded, powering on disk drive 702 is postponed at step 906. In an embodiment of the present invention, a request for powering on disk drive 702 is then sent by test-moderator 706 at predefined intervals to power controller 704, until power is available i.e., the power budget has not been exceeded. In another embodiment of the present invention, power controller 704 checks power availability at predefined intervals, if powering on is postponed. In an exemplary embodiment, the predefined interval is five minutes.

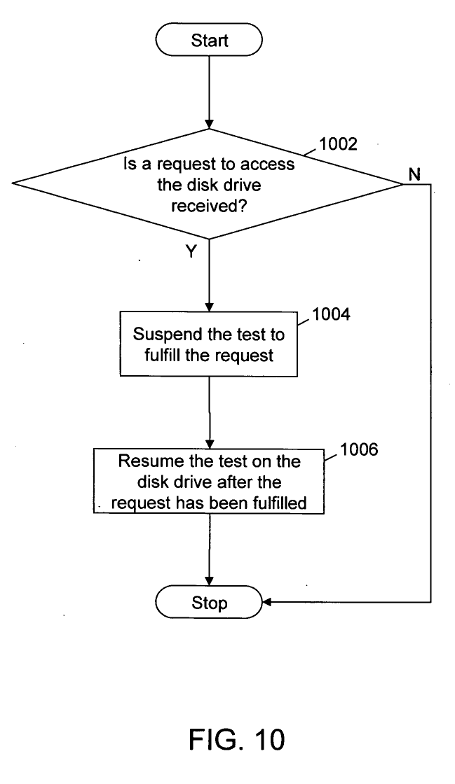

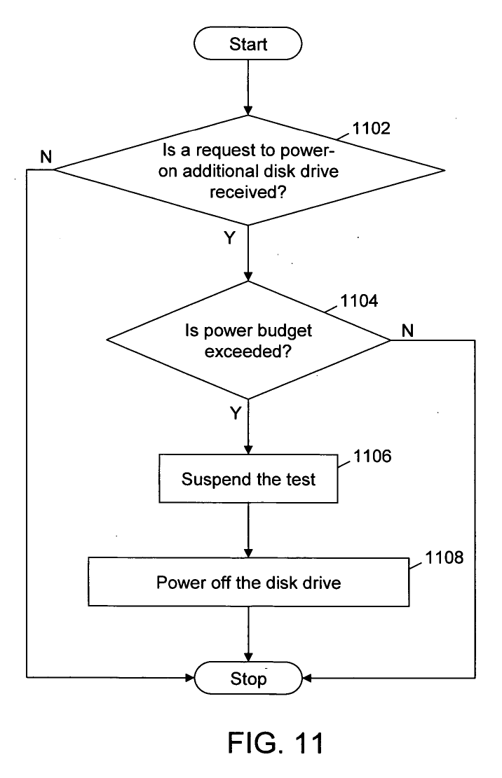

However, if the power budget has not been exceeded, i.e., power is available, disk drive 702 is powered on at step 908. Thereafter, a test is executed on disk drive 702 at step 910. This is further explained in conjunction with FIG. 10 and FIG. 11. Examples of the test performed at step 910 can be, for example, a buffer test, a write test, a random read test, a read scan test, or their combinations thereof. After the test is executed, disk drive 702 is powered off at step 912. At step 914, it is then determined whether the test has failed. If the test has not failed, the method returns to step 902 and the method is repeated. In an embodiment of the present invention, the method is repeated at predetermined intervals. In an exemplary embodiment of the present invention, the predetermined interval is 30 days. However, if it is determined at step 914 that the test has failed, an indication is given that disk drive 702 should be replaced at step 916.

FIG. 10 is a flowchart of a method for executing a test on disk drive 702, in accordance with an embodiment of the present invention. After test-moderator 706 has executed the test on disk drive 702, it is determined whether a request from a computer is received, to access disk drive 702, at step 1002. This step is performed by test-moderator 706. If a request to access disk drive 702 is received from a computer, the test is suspended, to fulfill the request at step 1004. Once the request is fulfilled, the test is resumed at the point where it was suspended, at step 1006. This means that a request from a computer is given higher priority, as compared to executing a test on disk drive 702. However, if a request from a computer to access disk drive 702 is not received, the test is executed till completion.

FIG. 11 is a flowchart of a method for executing a test on disk drive 702, in accordance with an embodiment of the present invention. After test-moderator 706 has executed the test on disk drive 702, it is determined whether a request to power on an additional disk drive in storage system 100 has been received at step 1102. Power controller 704 performs this step. CPU 104 sends a request to power on the additional disk drive, in response to a request from a computer to access the additional drive. If a request to power on an additional disk drive in storage system 100 is received, it is then determined whether powering on the additional disk drive will result in the power budget being exceeded at step 1104. However, if a request to power on an additional disk drive in storage system 100 is not received, the test is executed till completion.

If it is determined at step 1104 that the power budget has been exceeded, the test on disk drive 702 is suspended at step 1106. Disk drive 702 is then powered off at step 1108. Thereafter, the additional disk drive is powered on. In an embodiment of the present invention, if disk drive 702 is powered off, the request for powering on disk drive 702 is sent by test-moderator 706 at preset intervals to power controller 704, until power is available. In another embodiment of the present invention, if powering on is postponed, power controller 704 checks power availability at preset intervals. In an exemplary embodiment of the present invention, the preset interval is five minutes. This means that a request for powering on an additional disk drive is given higher priority, as compared to executing the test on disk drive 702. However, if it is determined at step 1104 that the power budget has not been exceeded, the test is executed till completion and the additional disk drive is also powered on.

Embodiments of the present invention provide a method and apparatus for maintaining a particular disk drive in a storage system, where the particular disk drive is powered off. The method and apparatus predicts the impending failures of disk drives that are not used or used infrequently. This further improves the reliability of the storage system.

One embodiment of the present invention uses disk drive checking to proactively perform data restore operations. For example, error detection tests such as raw read error rate, seek error rate, RSC rate or changing rate, number and frequency of timeout errors, etc., can be performed at intervals as described herein, or at other times. In another example, error detection tests such as the buffer test, write test on a plurality of heads in the disk drive, random read test, random read test with auto defect reallocation, read scan test and read scan test with auto defect reallocation can be performed at intervals as described herein, or at other times. If a disk drive is checked and the results of a test or check indicate early onset failure then recovery action steps such as reconstructing or copying data into a replacement disk drive, can be taken. In an embodiment of the present invention, drive control 212 further ensures that data is reconstructed or copied into a replacement disk drive and further data is directed to the replacement disk drive. In another embodiment of the present invention, if a disk drive is checked and the results of a test or check indicate early onset failure then recovery action steps, such as powering up additional drives, backing up data, performing more frequent monitoring, etc, can be taken.

Embodiments of the present invention further provide a method, system and computer program product for maintaining data reliability in data storage systems. Each disk drive in the storage system is periodically checked. If the disk drive is damaged or is expected to be damaged in future, it is either repaired or replaced. Maintaining data reliability includes preventing loss of data in a particular disk drive, and repairing a particular disk drive in a storage system.

Embodiments of the present invention, described below, pertain to power-managed storage systems, for example, power-managed RAID storage systems or massive array of independent/inexpensive disk (MAID) storage systems. However, aspects of the present invention may also be applicable to storage systems that are not power-managed.

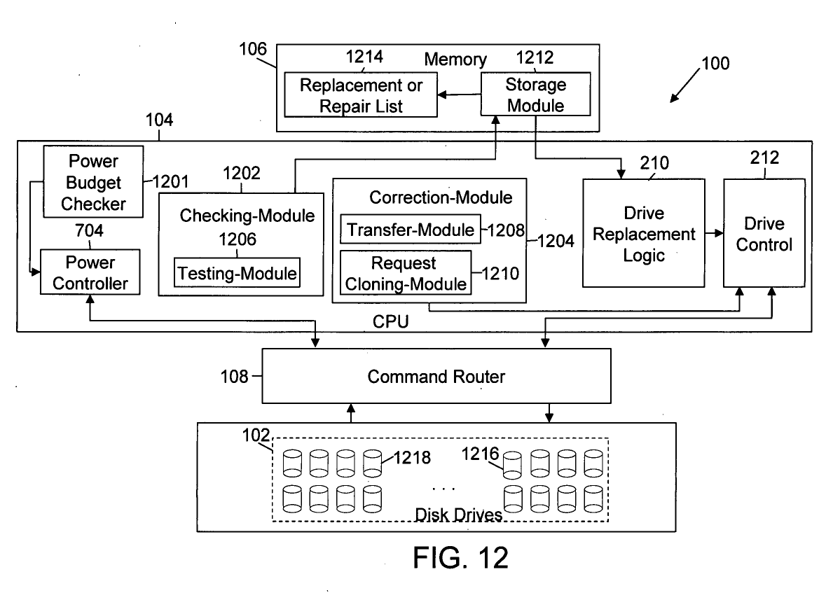

FIG. 12 is a block diagram illustrating the components of memory 106 and CPU 104, and their interaction, to prevent loss of data in a particular disk drive, in accordance with an embodiment of the present invention. In an embodiment of the present invention, disk drives 102 are arranged in a dual-level array in storage system 100. In another embodiment of the present invention, disk drives 102 are arranged in the form of RAID sets in storage system 100. Any suitable number, type and arrangement of storage devices can be used. In a power-managed array at least one disk drive in the array will be powered-down, or powered off. The power state of disk drives in a power-managed array will change, sometimes often. For purposes of discussion, disk drives 102 include at least one particular disk drive, for example, particular disk drive 1216 that is powered off. Disk drives 102 further include a plurality of spare disk drives. The plurality of spare disk drives includes a spare disk drive, for example, a spare disk drive 1218 that is powered off. CPU 104 includes a power budget checker 1201, a checking-module 1202 and a correction-module 1204. Power budget checker 1201 checks a power budget to determine that sufficient power is available to power on a RAID set (not shown in FIG. 12) that includes particular disk drive 1216. Checking-module 1202 checks particular disk drive 1216. Checking-module 1202 includes a testing-module 1206, which executes a test on particular disk drive 1216 to check particular disk drive 1216. When sufficient power is available, power controller 704 powers on particular disk drive 1216 in response to an input from testing-module 1206, when the test is to be executed. Power controller 704 further powers off particular disk drive 1216 after the test is executed. Memory 106 stores results obtained from the test in a storage module 1212. Memory 106 further stores a list of the disk drives that are marked for replacement or repair in a replacement or repair list 1214, which is generated based on the test results.

Correction-module 1204 corrects particular disk drive 1216. Correction-module 1204 includes a transfer-module 1208, and a request-cloning module 1210. Based on the test results, transfer-module 1208 transfers the data of a failing disk drive to a spare disk drive. Request cloning-module 1210 clones write requests for failing disk drives to spare disk drives. In an embodiment of the present invention, drive control 212 ensures that data is reconstructed or copied on the spare disk drive. In one embodiment of the present invention, drive control 212 ensures that a part of the data in the failing disk drive is reconstructed, and a part of the data is copied so that the spare disk drive contains all the data that was stored in the failing disk drive.

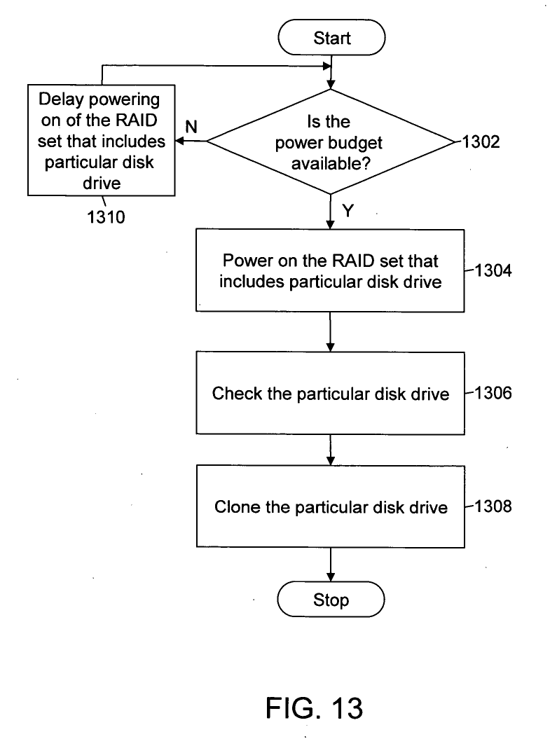

FIG. 13 is a flowchart of a method for preventing loss of data in particular disk drive 1216 in storage system 100, where particular disk drive 1216 is powered off, in accordance with an embodiment of the present invention. At step 1302, a power budget is checked to determine that sufficient power is available to power the RAID set that includes particular disk drive 1216. The RAID set that includes particular disk drive 1216 needs to be powered on in order to power on particular disk drive 1216. The step of checking the power budget is performed by power budget checker 1201. If the power budget is not available, then powering on the RAID set that includes particular disk drive 1216 is delayed at step 1310 until the power budget is available. In an embodiment of the present invention, power budget checker 1201 checks the power budget at predefined intervals. In an exemplary embodiment of the present invention, the predefined interval is five minutes.

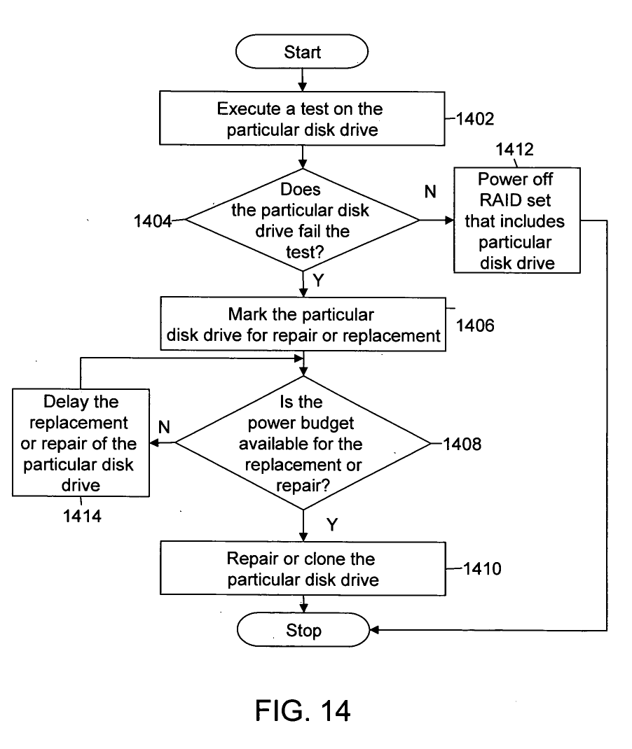

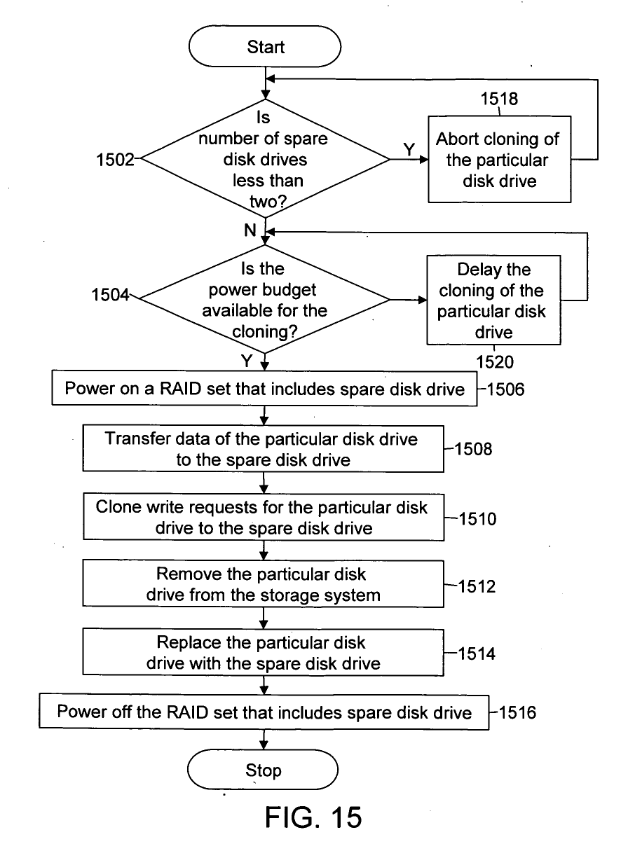

However, if the power budget is available, the RAID set that includes particular disk drive 1216 is powered on at step 1304. At step 1306, particular disk drive 1216 is checked for a failure or an expected failure. Checking-module 1202 checks particular disk drive 1216 at regular intervals. In an exemplary embodiment of the present invention, the predefined interval is five minutes. The step of checking is described later in conjunction with FIG. 14. At step 1308, particular disk drive 1216 is cloned. The step of cloning is performed in response to the step of checking. The step of cloning is described later in conjunction with FIG. 15.

FIG. 14 is a flowchart of a method for checking particular disk drive 1216 in storage system 100, in accordance with an embodiment of the present invention. At step 1402, the test is executed on particular disk drive 1216. The test is executed by testing-module 1206. The test is at least one, or a combination, of a buffer test, a read test or a read scan test. At step 1404, it is determined whether particular disk drive 1216 fails the test executed at step 1402. In various embodiments of the present invention, the results of the test performed on particular disk drive 1216 are stored in storage module 1212. In one embodiment of the present invention, the test results include a failure checkpoint byte. The value of the failure checkpoint byte is set according to the results of the test performed. In an embodiment of the present invention, a non-zero value is assigned to the failure checkpoint byte to indicate that the test has failed. For example, if particular disk drive 1216 fails the buffer test, the value of the failure checkpoint byte is set to one. If particular disk drive 1216 fails the read test, the value of the failure checkpoint byte is set to two. However, if the test is in progress, has not been started or has completed without error, the value of the failure checkpoint byte is set to zero.

In various embodiments of the present invention, drive replacement logic 210 also predicts the failure of particular disk drive 1216, based on the test results. In an exemplary embodiment of the present invention, if the failure checkpoint byte is set to a non-zero value, i.e., drive replacement logic 210 forecasts an impending failure of particular disk drive 1216.

If particular disk drive 1216 fails the test, it is marked for replacement or repair at step 1406. In an embodiment of the present invention, particular disk drive 1216 is marked for replacement or repair in repair and replacement list 1214. In another embodiment of the present invention, once the failure of particular disk drive 1216 is predicted, drive control 212 indicates that particular disk drive 1216 is to be repaired or replaced. In an embodiment of the present invention, the indication of replacement or repair is in the form of an LED or LCD that indicates which disk drive is failing. In another embodiment of the present invention, the indication is in the form of a message on a monitor that is connected to CPU 104. The indication can also include information pertaining to the location of particular disk drive 1216 and the reason for the prediction of the failure. Various other ways of indicating disk drive failure are also possible.

However, if particular disk drive 1216 does not fail the test, the RAID set that includes particular disk drive 1216 is powered off at step 1412. At step 1408, the power budget is checked to determine that sufficient power is available for replacement or repair of particular disk drive 1216. If the power budget is available, particular disk drive 1216 is repaired or cloned at step 1410. However, if the power budget is not available, then the replacement or repair of particular disk drive 1216 is delayed at step 1414 until the power budget is available. In an embodiment of the present invention, power budget checker 1201 checks the power at predefined intervals. In an exemplary embodiment of the present invention, the predefined interval is five minutes.

FIG. 15 is a flowchart of a method for cloning particular disk drive 1216 in storage system 100, in accordance with an exemplary embodiment of the present invention. At step 1502, it is determined whether the number of spare disk drives in disk drives 102 is less than two. If the number of spare disk drives in disk drives 102 is less than two, then the operation of cloning of particular disk drive is aborted at step 1518. The embodiments of the present invention are also applicable if the step of determining whether the number of spare disk drives in disk drives 102 is less than two is not performed. This implies that the embodiments of the present invention are also applicable when there is only one spare disk drive in disk drives 102. However, in this case, there is the possibility of loss of data when another disk drive in disk drives 102 unexpectedly fails during the correction of particular disk drive 1216. This is due to the unavailability of a spare disk drive to correct the disk drive that has failed unexpectedly.

However, if the number of spare disk drives in disk drives 102 is not less than two, then the power budget is checked to determine that sufficient power is available to power up the RAID set that includes particular disk drive 1216, at step 1504. If the power budget is available, a RAID set that includes spare disk drive 1218 is powered on at step 1506. The RAID set that includes spare disk drive 1218 is powered on by power controller 704. However, if the power budget is not available, then the cloning of particular disk drive 1216 is delayed at step 1520 until the power budget is available. In an embodiment of the present invention, power budget checker 1201 checks the power budget at predefined intervals. In an exemplary embodiment of the present invention, the predefined interval is five minutes.

At step 1508, the data of particular disk drive 1216 is transferred to spare disk drive 1218. In one embodiment of the present invention, transfer-module 1208 copies the data of particular disk drive 1216 on spare disk drive 1218 when the data can be read from all the logical blocks in particular disk drive 1216. In another embodiment of the present invention, transfer-module 1208 reconstructs the data of particular disk drive 1216 and stores the reconstructed data in spare disk drive 1218 when the data cannot be read from one or more logical blocks in particular disk drive 1216. The reconstruction of the data can be automated within storage system 100 by using data redundancy such as parity and its generation with the help of a central controller. In yet another embodiment of the present invention, transfer-module 1208 may perform a combination of copying a section of the data, reconstructing a section of the data, and mirroring a section of the reconstructed data and storing these sections in spare disk drive 1218.

At step 1510, write requests made by a host to access particular disk drive 1216 are cloned to spare disk drive 1218. Request cloning-module 1210 clones the write requests by directing the write requests to particular disk drive 1216 and spare disk drive 1218. The write requests are cloned so that the changes made in the data stored in particular disk drive 1216 are reflected in spare disk drive 1218. The requests to read data stored in particular disk drive 1216 are still directed to the particular disk drive 1216.

During the reconstruction or copying of the data of particular disk drive 1216 to spare disk drive 1218, particular disk drive 1216 is not removed from storage system 100. At this stage, a RAID set that includes particular disk drive 1216 in storage system 100 is in a full tolerance state. The full tolerance state of the RAID set that includes particular disk drive 1216 refers to capability of the RAID set that includes particular disk drive 1216 to function even in the event of the failure of particular disk drive 1216 or any other disk drive within the same RAID set.

After cloning of the write requests is complete, particular disk drive 1216 is removed from storage system 100 at step 1512. At step 1514, particular disk drive 1216 is finally replaced by spare disk drive 1218. This means that all write requests for particular disk drive 1216 are now directed to spare disk drive 1218. Therefore, the RAID set that includes particular disk drive 1216 never compromises its fault tolerance state. Particular disk drive 1216 can then be physically removed from storage system 100. At step 1516, the RAID set that includes spare disk drive 1218 is powered off.

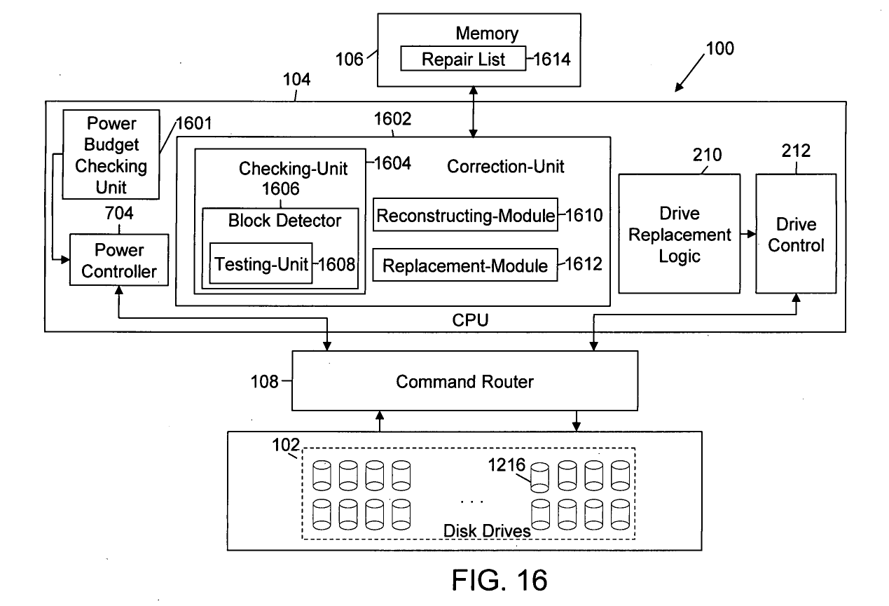

FIG. 16 is a block diagram illustrating the components of memory 106 and CPU 104, and their interaction, to repair a particular disk drive, in accordance with an embodiment of the present invention. CPU 104 includes a power budget checking unit 1601, and a correction-unit 1602. Power budget checking unit 1601 checks a power budget to determine that sufficient power is available to power on the RAID set that includes particular disk drive 1216. Correction-unit 1602 corrects the damaged logical blocks in particular disk drive 1216. Correction-unit 1602 includes a checking-unit 1604, a reconstructing-module 1610 and a replacement-module 1612. Checking-unit 1604 checks damaged logical blocks in particular disk drive 1216. Checking-unit 1604 includes a block detector 1606, which detects the damaged logical blocks in particular disk drive 1216. Block detector 1606 includes a testing-unit 1608, which executes a surface scrubbing test on each logical block of particular disk drive 1216. When sufficient power is available, and the surface scrubbing test is to be executed, power controller 704 powers on particular disk drive 1216, in response to a request from testing-unit 1608. Power controller 704 powers off particular disk drive 1216 after the surface scrubbing test is executed. Memory 106 stores the test results in a repair list 1614. Repair list 1614 is a list of LBAs corresponding to damaged logical blocks. The damaged logical blocks are the logical blocks of particular disk drive 1216 that fail the surface scrubbing test. Reconstructing-module 1610 reconstructs the damaged logical blocks in the particular disk drive 1216. Replacement-module 1612 replaces the damaged logical blocks with good logical blocks.

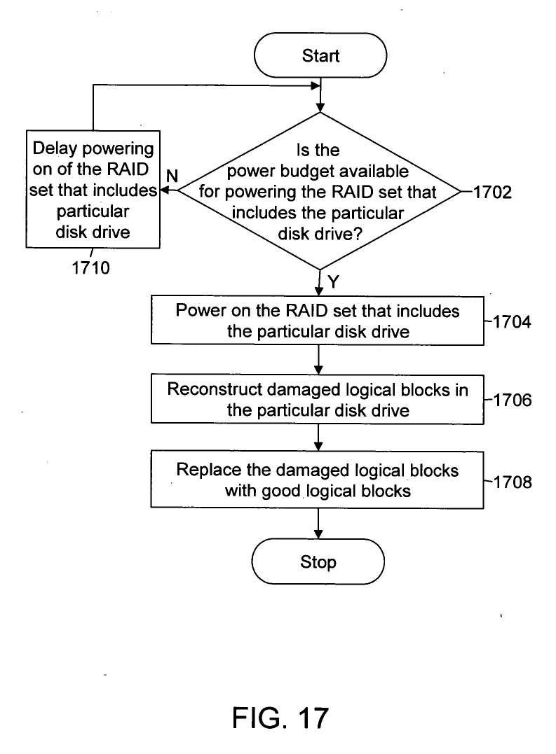

FIG. 17 is a flowchart of a method for repairing particular disk drive 1216 in storage system 100, where particular disk drive 1216 is powered off, in accordance with an embodiment of the present invention. At step 1702, a power budget is checked to determine that sufficient power is available to power on the RAID set that includes particular disk drive 1216. The step of checking the power budget is performed by power budget checking unit 1601. If the power budget is not available, then the powering on of the RAID set that includes the particular disk drive 1216 is delayed at step 1710 until the power budget is available. In an embodiment of the present invention, power budget checking unit 1601 checks the availability of power at predefined intervals. In an exemplary embodiment of the present invention, the predefined interval is five minutes.

However, if the power budget is available, the RAID set that includes particular disk drive 1216 is powered on at step 1704. At step 1706, damaged logical blocks in particular disk drive 1216 are reconstructed, and rewritten to particular disk drive 1216 on good logical blocks of particular disk drive 1216. At step 1708, the damaged logical blocks are corrected by replacing the damaged logical blocks with the good logical blocks. The good logical blocks are the logical blocks of particular disk drive 1216 that are not damaged.

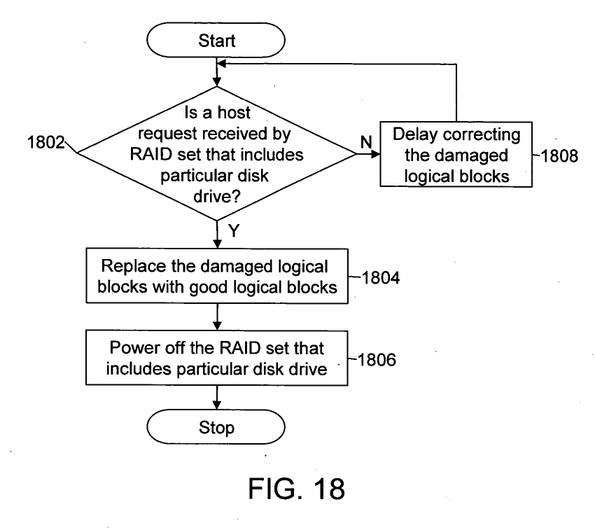

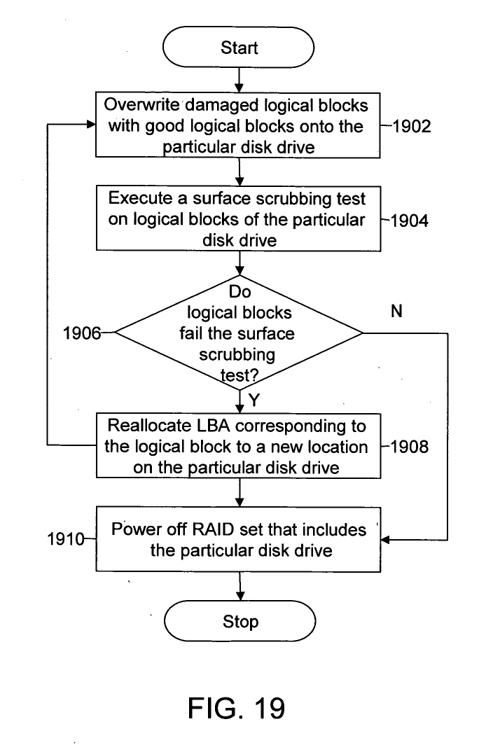

FIG. 18 is a flowchart of a method for correcting damaged logical blocks in particular disk drive 1216 in storage system 100, in accordance with an embodiment of the present invention. At step 1802, it is determined whether a host request is received by particular disk drive 1216 through the RAID set that includes the particular disk drive 1216. The host request can be received by the RAID set that includes particular disk drive 1216, only if the RAID set that includes particular disk drive 1216 is powered on, i.e. if sufficient power budget is available. If no host request is received by the RAID set that includes particular disk drive 1216, then at step 1808, correction of particular disk drive 1216 is delayed until a host request is received or until the power budget is available to power on the RAID set that includes particular disk drive 1216. In another embodiment of the present invention, the correction of particular disk drive 1216 is performed even if no host request is received for the RAID set that includes particular disk drive 1216. If the host request has been received by particular disk drive 1216 through the RAID set that includes particular disk drive 1216, then at step 1804, the damaged logical blocks are replaced with the good logical blocks. The step of replacement is described later in conjunction with FIG. 19. Finally, at step 1806, the RAID set that includes particular disk drive 1216 is powered off.

FIG. 19 is a flowchart of a method for replacing the damaged logical blocks with the good logical blocks in particular disk drive 1216 in storage system 100, in accordance with an embodiment of the present invention. At step 1902, the damaged logical blocks are overwritten with the good logical blocks onto particular disk drive 1216. The data written on the good logical blocks has hereinafter been referred to as new data. At step 1904, a surface scrubbing test is executed on each logical block, including the good logical blocks of particular disk drive 1216. The surface scrubbing test is executed by testing-unit 1608, to verify the integrity of the new data. As a part of the surface scrubbing test, the new data is read and compared to the data that was previously written on the damaged logical blocks. Further, new ECCs are also checked during data read of each logical block. The surface scrubbing test fails either when there is a mismatch in the new data and the previously written data, or when an ECC check status is returned.

At step 1906, it is determined whether any logical block has failed the surface scrubbing test. If any logical block has failed the surface scrubbing test, then at step 1908, the logical block is reallocated a new address or LBA on particular disk drive 1216. In other words, an LBA corresponding to the damaged logical block is reallocated to a new location on particular disk drive 1216. After the reallocation, steps 1902-1908 are repeated. However, if no logical block has failed the surface scrubbing test, then at step 1910, the RAID set that includes particular disk drive 1216 is powered off.

The embodiments of the present invention ensure the maintenance of data-reliability in a particular disk drive. One embodiment of the present invention provides a method and system for preventing loss of data in the particular disk drive in a storage system where the particular disk drive is powered off. The method and system ensure replacement or repair of disk drives that are expected to fail in future, in addition to the replacement or repair of disk drives that have already failed. Further, the method and system substantially reduce the time taken to replace the damaged or failing disk drives. The disk drive that is to be replaced is not removed from the storage system immediately. Instead, it is removed after the data of the disk drive has been transferred to a spare disk drive. Further, the method and system ensures that the repair or replacement is made within an allocated power budget.

Another embodiment of the present invention provides a method and system for repairing disk drives in a storage system. The method and system enables detection and subsequent repair of degraded disk drives in the storage system. Further, the method and system ensure that the repair is carried out within an allocated power budget.

Although the present invention has been described with respect to the specific embodiments thereof, these embodiments are descriptive, and not restrictive, of the present invention, for example, it is apparent that specific values and ranges of parameters can vary from those described herein. The values of the threshold parameters, p, c, r, m, s, t, etc., can change as new experimental data become known, as preferences or overall system characteristics change, or to achieve improved or desirable performance.

Although terms such as “storage device,” “disk drive,” etc., are used, any type of storage unit can be adaptable to work with the present invention. For example, disk drives, tape drives, random access memory (RAM), etc., can be used. Different present and future storage technologies can be used such as those created with magnetic, solid-state, optical, bioelectric, nano-engineered, or other techniques.

Storage units can be located either internally inside a computer or outside a computer in a separate housing that is connected to the computer. Storage units, controllers and other components of systems discussed herein can be included at a single location or separated at different locations. Such components can be interconnected by any suitable means such as with networks, communication links or other technology. Although specific functionality may be discussed as operating at, or residing in or with, specific places and times, in general the functionality can be provided at different locations and times. For example, functionality such as data protection steps can be provided at different tiers of a hierarchical controller. Any type of RAID or RAIV arrangement or configuration can be used.

In the description herein, numerous specific details are provided, such as examples of components and/or methods, to provide a thorough understanding of embodiments of the present invention. One skilled in the relevant art will recognize, however, that an embodiment of the present invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

A “processor” or “process” includes any human, hardware and/or software system, mechanism, or component that processes data, signals, or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real time,” “offline,” in a “batch mode,” etc. Moreover, certain portions of processing can be performed at different times and at different locations, by different (or the same) processing systems.

Reference throughout this specification to “one embodiment”, “an embodiment”, or “a specific embodiment” means that a particular feature, structure, or characteristic described in connection with the embodiment is included in at least one embodiment of the present invention and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope of the present invention to implement a program or code that can be stored in a machine-readable medium to permit a computer to perform any of the methods described above.

Additionally, any signal arrows in the drawings/figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a”, “an”, and “the” includes plural references unless the context clearly dictates otherwise. In addition, as used in the description herein and throughout the claims that follow, the meaning of “in” includes “in” and “on” unless the context clearly dictates otherwise.

The foregoing description of illustrated embodiments of the present invention, including what is described in the Abstract, is not intended to be exhaustive or to limit the present invention to the precise forms disclosed herein. While specific embodiments of, and examples for, the present invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes, and substitutions are intended in the foregoing disclosures. It will be appreciated that in some instances some features of embodiments of the present invention will be employed without a corresponding use of other features without departing from the scope and spirit of the present invention as set forth. Therefore, many modifications may be made to adapt a particular situation or material to the essential scope and spirit of the present invention. It is intended that the present invention not be limited to the particular terms used in following claims and/or to the particular embodiment disclosed as the best mode contemplated for carrying out this invention, but that the present invention will include any and all embodiments and equivalents falling within the scope of the appended claims.

What is claimed is:

1. A method for preventing loss of data in a particular disk drive in a power-managed storage system, wherein the storage system includes a plurality of disk drives and a particular disk drive, wherein the particular disk drive is powered off, the method comprising:
checking a power budget to determine that sufficient power is available;
powering on the particular disk drive;
checking the particular disk drive; and
correcting the particular disk drive in response to the checking.

2. The method of claim 1, wherein checking the particular disk drive comprises:
executing a test on the particular disk drive; and
marking the particular disk drive for replacement based on the executed test.

3. The method of claim 2, wherein the test comprises at least one of a buffer test, a read test, and a read scan test.

4. The method of claim 1, wherein checking the particular disk drive is performed at predetermined intervals of time.

5. The method of claim 4, wherein the predetermined intervals of time are periodic.

6. The method of claim 1 further comprising delaying the correcting of the particular disk drive until a power budget is available.

7. The method of claim 1, wherein correcting the particular disk drive comprises:
transferring data of the particular disk drive to a spare disk drive; and
cloning one or more write requests for the particular disk drive to the spare disk drive.

8. The method of claim 7, wherein transferring data comprises at least one of:
copying the data to the spare disk drive, and
reconstructing the data on the spare disk drive.

9. The method of claim 7, wherein cloning the one or more write requests comprises:
directing the requests to the particular disk drive, and
directing the requests to the spare disk drive.

10. The method of claim 7 further comprising aborting correcting of the particular disk drive when a number of spare disk drives are less than two.

11. The method of claim 7 further comprising:
removing the particular disk drive from the storage system when the data has been transferred to the spare disk drive; and
replacing the particular disk drive with the spare disk drive.

12. The method of claim 1 further comprising powering off the spare disk drive.

13. The method of claim 1 further comprising delaying the powering on the particular disk drive until a power budget is available.

14. A system for preventing loss of data in a particular disk drive in a storage system, wherein the storage system includes a plurality of disk drives and a particular disk drive, wherein the particular disk drive is powered off, the apparatus comprising:
a power budget checker for checking power budget to determine that sufficient power is available;
a power controller for controlling power to the disk drives and the particular disk drive;
a checking-module for checking the particular disk drive; and
a correction-module for correcting the particular disk drive;
whereby, the particular disk drive is powered on by the power controller before the checking is to be performed.

15. The system of claim 14, wherein the checking-module comprises a testing-module for executing a test on the particular disk drive.

16. The system of claim 14, wherein the correction-module comprises;
a transfer-module for transferring data of the particular disk drive to a spare disk drive; and
a request cloning-module for cloning one or more write requests for data of the particular disk drive to the spare disk drive.

17. The system of claim 14, wherein the plurality of disk drives is arranged in a dual-level array in the storage system.

18. An apparatus for preventing loss of data in a particular disk drive in a storage system, wherein the storage system includes a plurality of disk drives and a particular disk drive, wherein the particular disk drive is powered off, the apparatus comprising:
a processor for executing instructions; and
a machine-readable medium including:
one or more instructions for checking a power budget to determine that sufficient power is available;
one or more instructions for powering-on the particular disk drive;
one or more instructions for checking the particular disk drive; and
one or more instructions for correcting the particular disk drive.

19. A machine-readable medium including instructions executable by a processor for preventing loss of data in a particular disk drive in a storage system, wherein the storage system includes a plurality of disk drives and a particular disk drive, wherein the particular disk drive is powered off, the machine readable medium comprising:
one or more instructions for checking a power budget to determine that sufficient power is available;
one or more instructions for powering-on the particular disk drive;
one or more instructions for checking the particular disk drive; and
one or more instructions for correcting the particular disk drive.

20. A method for repairing a particular disk drive in a storage system, wherein the storage system includes a plurality of disk drives and a particular disk drive, wherein the particular disk drive is powered off, the method comprising:
checking a power budget to determine that sufficient power is available;
powering on the particular disk drive; and
correcting the damaged logical blocks in response to the checking.

21. The method of claim 20, wherein correcting the damaged logical blocks comprises:
overwriting the damaged logical blocks with good logical blocks onto the particular disk drive;
executing a surface scrubbing test on each logical block; wherein each logical block comprises good logical blocks, and
relocating logical block addresses corresponding to the damaged logical blocks to a new location on the particular disk drive.

22. The method of claim 20, wherein the correcting is performed when the particular disk drive receives a host request.

23. The method of claim 20 further comprising powering off the particular disk drive.

24. The method of claim 20 further comprising delaying the powering on the particular disk drive until a power budget is available.

25. The method of claim 20 further comprising delaying the correcting of the damaged logical blocks until a host request is received.

26. A system for repairing a particular disk drive in a storage system, wherein the storage system includes a plurality of disk drives and a particular disk drive, wherein the particular disk drive is powered off, the apparatus comprising:
a power budget checking unit for checking a power budget to determine that sufficient power is available;
a power controller for controlling power to the disk drives and the particular disk drive; and
a correction-unit for correcting the damaged logical blocks;
whereby, the particular disk is powered-on by the power controller before the checking is to be performed.

27. The system of claim 26, wherein the correction-unit comprises a checking-unit for checking damaged logical blocks in the particular disk drive.

28. The system of claim 27, wherein the checking-unit comprises a block detector for detecting the damaged logical blocks that generate an error in an error correction code.

29. The system of claim 28, wherein the block detector comprises a testing-unit for executing a surface scrubbing test on each logical block of the particular disk drive.

30. The system of claim 26, wherein the correction-unit further comprises:
a reconstructing-module for reconstructing the damaged logical blocks in the particular disk drive; and
a replacement-module for replacing the damaged logical blocks with good logical blocks.

31. An apparatus for repairing a particular disk drive in a storage system, wherein the storage system includes a plurality of disk drives and a particular disk drive, wherein the particular disk drive is powered off, the apparatus comprising:
a processor for executing instructions; and
a machine-readable medium including:
one or more instructions for checking a power budget to determine that sufficient power is available;
one or more instructions for powering-on the particular disk drive; and
one or more instructions for correcting the damaged logical blocks.

32. A machine-readable medium including instructions executable by a processor for repairing a particular disk drive in a storage system, wherein the storage system includes a plurality of disk drives and a particular disk drive, wherein the particular disk drive is powered off, the machine readable medium comprising:
one or more instructions for checking a power budget to determine that sufficient power is available;
one or more instructions for powering-on the particular disk drive; and
one or more instructions for correcting the damaged logical blocks.
